(19) United States
(12) Patent Application Publication
(10) Pub. No.: US 2015/0199769 A1
(43) Pub. Date: Jul. 16, 2015

(54) VENDOR OPTIMIZATION IN AGGREGATED ENVIRONMENTS

(71) Applicant: Empire Technology Development LLC, Wilmington, DE (US)

(72) Inventor: Ezekiel Kruglick, Poway, CA (US)

(21) Appl. No.: 14/640,933

(22) Filed: Mar. 6, 2015

Related U.S. Application Data
(62) Division of application No. 13/510,277, filed on May 16, 2012.

(51) Int. Cl. G06Q 40/00; G06Q 30/06

(52) U.S. Cl. CPC G06Q 40/12; G06Q 30/0633

(57) ABSTRACT

Technologies are generally described for systems and methods effective to optimize vendors in a cloud computing environment. In an example, bundled services can be de-aggregated and a hierarchical tree can be generated showing the relationships between the service providers and infrastructure providers. When itemized bills are received from the service providers, the hierarchical tree can be used to match items from the itemized bills to specific infrastructure providers. A transaction report showing all the services rendered by the infrastructure providers can then be sent to the respective infrastructure providers to take advantage of discounts and bulk rates. In another example, a set of infrastructure providers that provide the services at the lowest cost can be determined, and the service providers can be configured or requested to switch to that set of infrastructure providers.

### CROSS REFERENCE TO RELATED APPLICATIONS

This application is a divisional of, and claims priority to, U.S. patent application Ser. No. 13/510,277, filed on May 16, 2012, entitled “VENDOR OPTIMIZATION IN AGGREGATED ENVIRONMENTS”, which is a U.S. National Stage filing of PCT Patent Application No. PCT/US11/43229, filed Jul. 7, 2011, and entitled “VENDOR OPTIMIZATION IN AGGREGATED ENVIRONMENTS,” The entireties of the foregoing applications listed herein are hereby incorporated by reference.

### TECHNICAL FIELD

The subject disclosure relates generally to vendor optimization in cloud computing environments.

### BACKGROUND

Cloud computing uses the Internet or other networks to provide access to services that are based in the cloud and not stored locally. A typical cloud computing environment can consist of multiple layers, aggregated together, that interact with each other to provide resources for end-users. Software as a Service (SaaS), Platform as a Service (PaaS), and Infrastructure as a Service (IaaS) can all be layers that constitute the “cloud”. SaaS layers can provide on-demand applications that eliminate the need to install and run the application on the customer's own computers. PaaS layers can deliver a computing platform and a solution stack as a service that facilitates the deployment of applications. IaaS layers can deliver computer infrastructure such as storage or computing power as a service.

Any of these layers can be accessed by an end-user, but the interactions between the layers can be opaque to the end-user. If the end-user is accessing one of the layers, the end-user is generally not privy to the interactions between that layer and the other layers. Payments for services between the layers are typically made on a utility basis, with set amounts paid for total storage costs, computing time, and etc. These aggregated costs are then passed on to the end-user via a bill prepared by the layer that the end-user accessed.

The layers that do not interface directly with the end-user also typically don't know the ultimate recipients of their resources and services. This lack of information on the part of the end-user and the background layers means that the end-users are unable to negotiate special rates with the background layers. Similarly, the background layers cannot offer discounts or bulk rates for end-users that use their services and resources.

The above-described deficiencies of conventional approaches to cloud computing environments are merely intended to provide an overview of some of the problems of conventional approaches and techniques, and are not intended to be exhaustive. Other problems with conventional systems and techniques, and corresponding benefits of the various non-limiting embodiments described herein may become further apparent upon review of the following description.

### SUMMARY

In various non-limiting embodiments, systems and methods are provided to allow optimization of vendors in an aggregated environment. In an example embodiment, a method comprises de-aggregating bundled services into top-level services and sub-services, mapping the top-level services and the sub-services to create a hierarchical dependency tree and configuring dependencies of the top-level services and the sub-services including modifying the hierarchical dependency tree based on a set of rules and re-consolidating the sub-services.

In another example embodiment, a system comprises a de-aggregation component configured to analyze bundled services and extract information about services of the bundled services, and a mapping component configured to generate a hierarchical tree of services and infrastructure providers as a function of the information about the bundled services, wherein the hierarchical tree of services represents relationships between the service providers and the infrastructure providers. The system can further include a configuration engine component configured to modify the relationships between the services and the infrastructure providers based on a set of rules.

In another example embodiment, a method comprises receiving itemized bills from a plurality of service providers, accessing a hierarchical tree of the service providers and infrastructure providers, matching items on the itemized bills from the plurality of service providers to services provided by the infrastructure providers including analyzing the hierarchical tree, and sending a consolidated listing of the services provided by respective infrastructure providers to the infrastructure providers.

In another example embodiment, a computer readable storage medium has computer executable instructions that, in response to execution, cause a computing system to perform operations comprising receiving itemized bills from respective service providers, creating a listing of services provided by infrastructure providers based on the itemized bills, wherein the listing of services comprises a price and a usage of the services and consolidating the infrastructure providers by configuring the service providers to switch to common infrastructure providers.

In another example embodiment, a system comprises a billing component configured to receive itemized bills from service providers, a matching component configured to analyze the itemized bills and a hierarchical tree of the service providers and infrastructure providers, and match items from the itemized bills to the infrastructure providers and a grouping component configured to cluster the items matched to the infrastructure providers and send the infrastructure providers a grouped transaction report.

In another example embodiment, a system comprises a set creation component configured to create sets of infrastructure providers, wherein the sets of the infrastructure providers are configured to provide a set of services used by service providers, a selection component configured to analyze a price per usage and a usage of infrastructure providers in the sets of infrastructure providers and select a set of infrastructure providers from the sets with a lowest cost, and a consolidation component configured to send a request to modify a configuration of the service providers to switch to the set of infrastructure providers selected by the selection component.

In another example embodiment, a system comprises means for matching items on itemized bills from a plurality of service providers to services provided by a plurality of infrastructure providers, means for consolidating the items from the itemized bills into groups based on the services provided by the plurality of infrastructure providers, and means for sending a consolidated list of the services provided by an infrastructure provider to the plurality of infrastructure providers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

Various non-limiting embodiments are further described with reference to the accompanying drawings in which:

FIG. 1 is a block diagram illustrating an example, non limiting embodiment of a system for creating a hierarchical tree of service providers and infrastructure providers;

FIG. 2 is a block diagram illustrating an example, non-limiting embodiment of a system for modifying relationships and dependencies between service providers and infrastructure providers;

FIG. 3 is a block diagram illustrating an example, non-limiting embodiment of a system for creating and modifying a hierarchical tree of services providers and infrastructure providers;

FIG. 4 illustrates a flow diagram of an example, non-limiting embodiment of a method for configuring dependencies of top-level services and sub-services;

FIG. 5 illustrates a flow diagram of an example, non-limiting embodiment of a method for generating and modifying a hierarchical dependency tree of top-level services and sub-services;

FIG. 6 is a block diagram illustrating an example, non-limiting embodiment of a billing system for sending infrastructure providers a consolidated transaction report;

FIG. 7 illustrates a flow diagram of an example, non-limiting embodiment of a method for sending a consolidated listing of services to infrastructure providers;

FIG. 8 illustrates a flow diagram of an example, non-limiting embodiment of a set of computer-readable instructions for consolidating infrastructure providers used by service providers;

FIG. 9 is a block diagram illustrating an example, non-limiting embodiment of a system for selecting infrastructure providers;

FIG. 10 is a block diagram illustrating an example computing device that is arranged for at least some of the embodiments of the subject disclosure; and

FIG. 11 is a block diagram illustrating an example networking environment that can be employed in accordance with the claimed subject matter.

### DETAILED DESCRIPTION

### Overview

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In the detailed description, reference is made to “service providers” and “infrastructure providers”. For the sake of simplicity, service providers (or top-level services), can be defined as providing services to the customer or end-user, while infrastructure providers (or sub-services), provide services and resources to the service providers. It is to be noted that the end-users can interact with any of the SaaS, PaaS, or IaaS layers, and are not limited to interacting with only one type of layer. Accordingly, each of the service providers and infrastructure providers can be any one of a SaaS, PaaS, or IaaS layer.

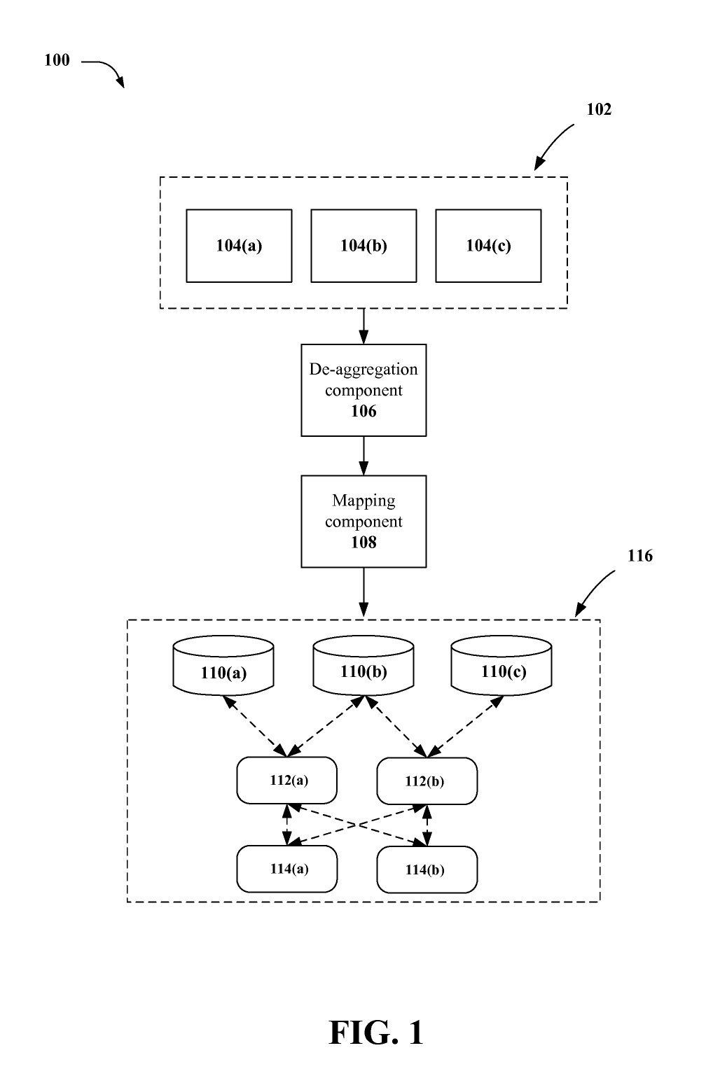

Turning now to FIG. 1, a block diagram of an example, non-limiting embodiment of a system for creating a hierarchical tree of service providers and infrastructure providers is shown. As shown in FIG. 1, a de-aggregation system 100 is provided to break down a set of bundled services 102 which contains bundled services 104(a)-104(c). A de-aggregation component 106 can receive the bundled services and de-aggregate them into service providers 112(a), 112(b), 114(a), and 114(b) and infrastructure providers 110(a), 110(b), and 110(c). A mapping component 108 can generate a hierarchical tree 116 showing the relationships and dependencies of the vendors. For the sake of simplicity, FIG. 1 shows one layer of infrastructure providers and two layers of service providers, but hierarchical tree 116 can contain any number of layers and combinations of infrastructure and service providers.

In one example, the set of bundled services 102 can be all, or some portion of, the cloud services to which a customer uses or subscribes. The set of bundled services 102 can be any combination of private and public cloud services. The set of bundled services 102 can include bundled services 104(a), 104(b) and 104(c). The bundled services can exist in a private cloud network or in a public cloud network.

De-aggregation component 106 can be configured to analyze the bundled services 104(a) through 104(c) and extract information about the service providers 112(a), 112(b), 114(a), and 114(b) and infrastructure providers 110(a) through 110(c). It is to be appreciated that while FIG. 1 depicts the bundled services including four service providers and three infrastructure providers, the bundled services can include any number and/or combination of service providers and infrastructure providers.

The information extracted by de-aggregation component 110 can identify the service providers used by the bundled service provider. The information can relate to the infrastructure providers that are actually used by the service providers, and can also identify the infrastructure providers that are capable of being used by the service providers but which are not actually being used. By way of example, in hierarchical tree 116, service provider 112(a) can be capable of using both infrastructure provider 110(a) and 110(b), but not 110(c). Similarly, service provider 112(b) can be capable of using infrastructure providers 110(b) and 110(c), but not infrastructure provider 110(a).

In one embodiment, de-aggregation component 106 can extract the information about relationships between the service providers and infrastructure providers by monitoring the bundled services and logging information about the services that each module or package of the bundled service calls. In another embodiment, when de-aggregation component 106 is unable to monitor the service calls made by modules within the bundled service, de-aggregation component 106 can be configured to receive a pre-specified list of the relationships between the service providers and the infrastructure providers. By way of example, de-aggregation component 106 may receive this information in response to sending a request to service providers identified in the bundled service to determine the infrastructure providers that are used, or are capable of being used.

In a further embodiment, de-aggregation component 106 can extract the information about relationships between the service providers and infrastructure providers by parsing configuration files, scripts, or headers for services and infrastructure code. For example, an SaaS service can be a mixture of scripts and executables and de-aggregation component 106 can load the scripts and configuration files and parse them looking for information on available or realized infrastructure components. When de-aggregation component 106 finds pointers, locations, network addresses, or other information on infrastructure elements de-aggregation component 106 can further change to the indicated directory or machine and repeat the search for configuration files, scripts, headers, etc. This search can be conducted by one or multiple threads descending into each sub-directory (hierarchical searching) and following links to other machines, directories, or network locations and repeating the hierarchical search at those locations. The process continues until there are no further leads on infrastructure elements and no further directories or machines to explore. In a further embodiment, an audit of the aggregated service can be performed by a third party, and the results can be analyzed by de-aggregation component 106 to extract the information. Alternatively, the vendor can provide a table listing top-level services and sub-services which can be analyzed by de-aggregation component 106 to compile information about the service providers and infrastructure providers. These external references can be provided in the form of tables or lists, or can take the form of a separate web service or API which de-aggregation component 106 may query with identifying information on the top-level service and/or provider.

Mapping component 108 can create a data store using the information extracted by de-aggregation component 106. Mapping component 108 can also be configured to generate hierarchical tree 116 as a function of the information about the bundled services. Hierarchical tree 116 can represent relationships between the service providers 112(a), 112(b), 114(a), and 114(b) and the infrastructure providers 110(a), 110(b), and 110(c). While hierarchical tree 116 shows only two service providers and three infrastructure providers, mapping component 108 can create a hierarchical tree with any number and/or combination of service providers and infrastructure providers.

Mapping component 108 can generate hierarchical tree 116 by analyzing the dependency and relationship information extracted by de-aggregation component 106. Mapping component 108 can create hierarchical tree 116 based on not just the service providers that rely on the infrastructure providers, but also on all potential relationships. The nodes of the tree may include additional data such as cost, availability conditions, contact information, or network addresses relating to the infrastructure services and potential infrastructure services.

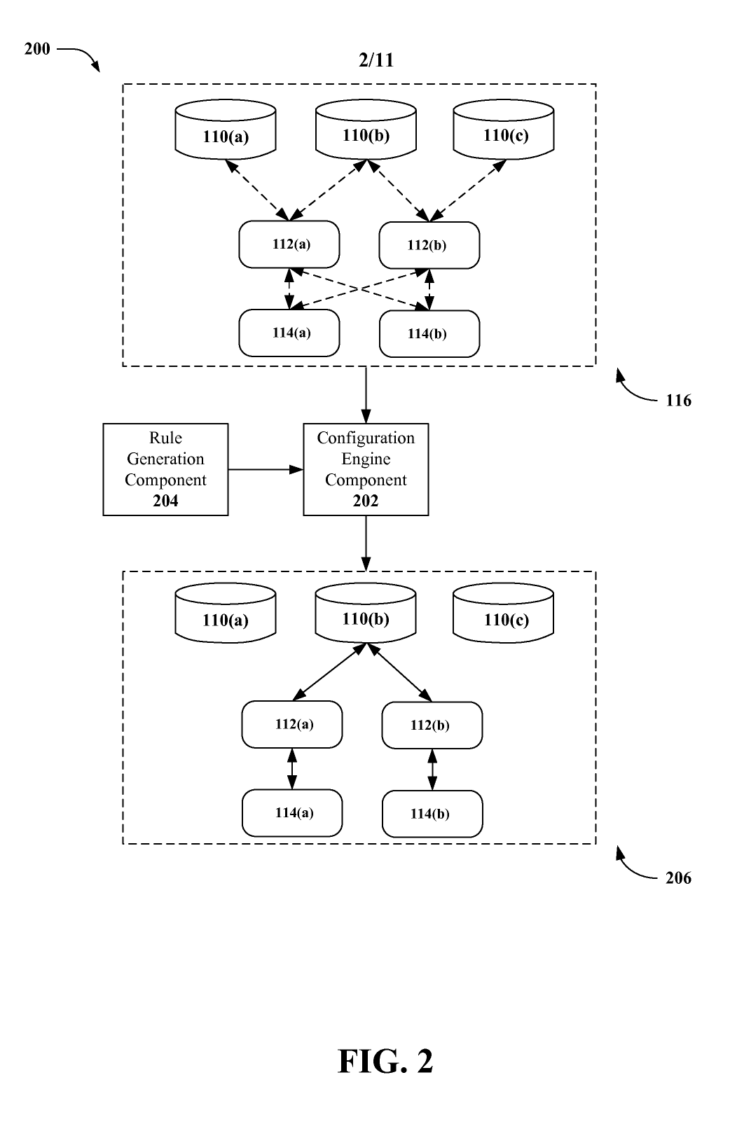

Turning now to FIG. 2 a block diagram illustrating an example, non-limiting embodiment of a system for modifying relationships and dependencies between service providers and infrastructure providers is shown. As shown in FIG. 2, a configuration system 200 is provided to manage relationships and dependencies between the service providers and the infrastructure providers. A configuration engine component 202 modifies the dependencies of the service providers and infrastructure providers represented in hierarchical tree 116 using a set of rules provided by a rule generation component 204. A modified hierarchical tree 206 represents the modified relationships and dependencies.

Configuration engine component 202 can be configured to modify hierarchical tree 116 by changing the relationships and dependencies of service providers 112(a) through 114(b) and infrastructure providers 110(a), 110(b), and 110(c) to any possible combination that is compatible with the service and infrastructure providers. For example, as show in hierarchical tree 116, service provider 112(a) can use either of infrastructure providers 110(a) and 110(b), while service provider 112(b) is compatible with infrastructure providers 110(b) and 110(c). Configuration engine component 202 can modify the relationships, and can be configured to consolidate infrastructure providers such that service providers 112(a) and 112(b) both use infrastructure provider 110(b) as shown in modified hierarchical tree 206. Also, service providers 114(a) and 114(b) can be configured to use service providers 112(a) and 112(b), respectively. It is to be appreciated that configuration engine component 202 is not limited to modifying the relationships as shown in modified hierarchical tree 206, but can also create any number and/or combination of possible dependencies.

In one embodiment, configuration engine component 202 can have access to the SaaS layer service providers. In this embodiment, configuration engine component 202 can manually modify the relationships by configuring the SaaS layer service providers to use a specific infrastructure provider.

In another embodiment, configuration engine component 202 may lack access or rights to directly modify the relationships of the service providers. In this example, configuration engine component 202 can send a request to the service provider to change the relationships in accordance with the set of rules.

In one embodiment, to guide configuration engine component 202, rule generation component 204 can be configured to create a set of rules that configuration engine component 202 can follow or apply in modifying the relationships. The rules can be dynamically created based on a price level or volume of usage of the infrastructure provider. Rule generation component 204 can also maintain a database of subscriptions that the customer has with infrastructure providers and create rules to modify the dependencies of the service providers so that specific infrastructure providers are preferentially used based on the subscriptions the customer has. Rule generating component 204 may also derive information from the hierarchical tree 116.

In a further embodiment, rule generation component 204 can determine whether infrastructure providers have discounts or bulk rates, and create a set of rules that preferentially select those infrastructure providers. Alternatively, the rule generation component can be configured to create rules to consolidate the services provided by the infrastructure layer into as few infrastructure providers as possible.

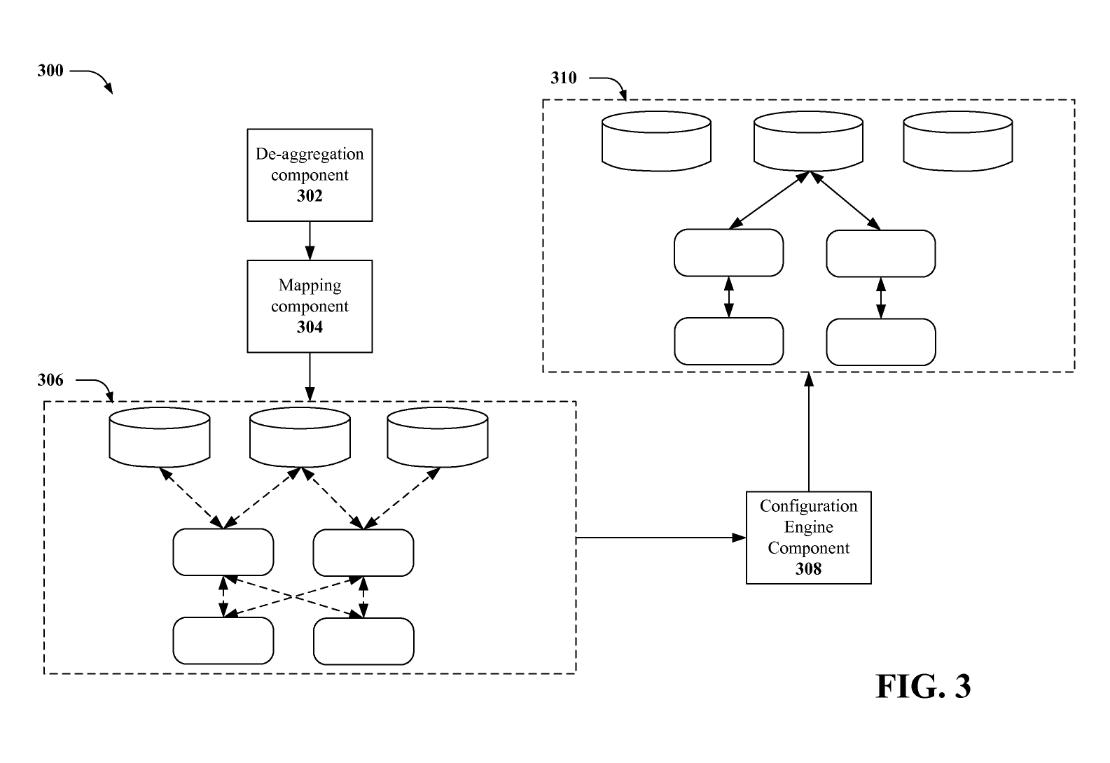

Turning now to FIG. 3, a block diagram illustrating an example, non-limiting embodiment of a system 300 for creating and modifying a hierarchical tree of services providers and infrastructure providers is shown. System 300 is a representation of systems 100 and 200 (as shown in FIG. 1 and FIG. 2 respectively) combined together.

A de-aggregation component 302 can be configured to analyze bundled services, and extract information relating to services in the bundled services. The bundled services can exist in a private cloud network or a public cloud network, and can include service providers and infrastructure providers. The information extracted by de-aggregation component 302 can identify the infrastructure providers that are being used, and can potentially be used by the service providers.

Using the information extracted by de-aggregation component 302, a mapping component 304 can be configured to generate a hierarchical tree 306 of service providers and infrastructure providers. Hierarchical tree 306 can display the relationships between the infrastructure providers and service providers. Hierarchical tree 306 can show actual relationships, i.e., the infrastructure providers that are being used by the service providers, as well as show potential relationships between infrastructure providers and service providers.

A configuration engine component 308 can be configured to modify the relationships between the service providers and the infrastructure providers in accordance with a set of rules. The rules can be based on cost, or volume of usage of an infrastructure provider. Configuration engine component 308 can also modify the relationships so as to consolidate the number of infrastructure providers. This can be shown in modified hierarchical tree 310.

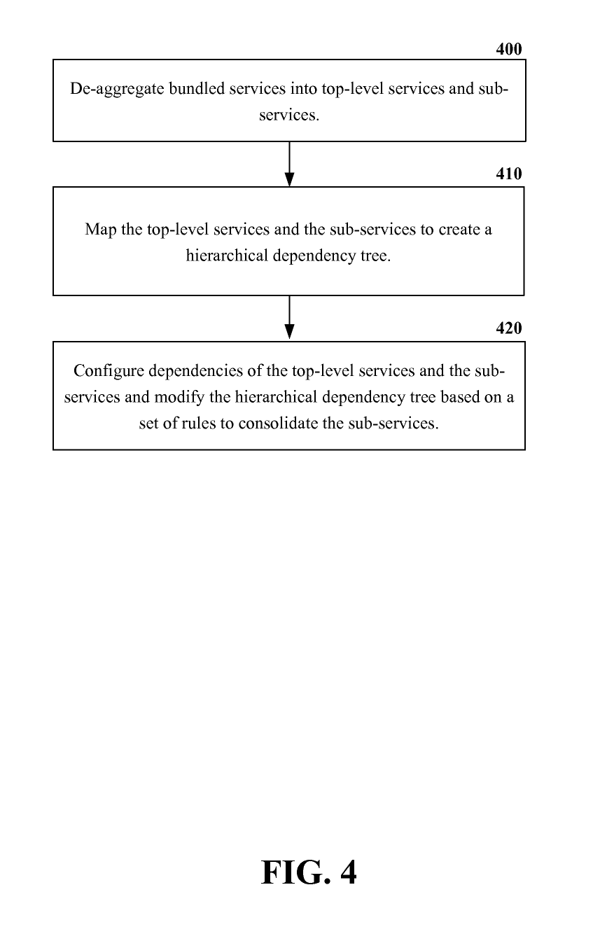

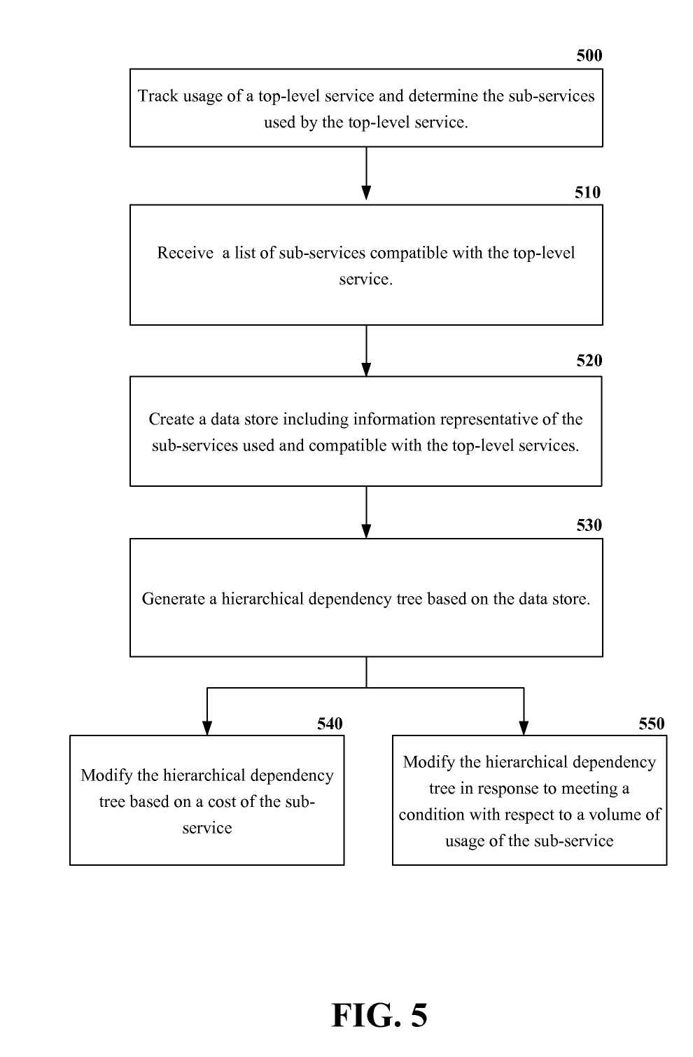

FIG. 4-FIG. 5 illustrate processes in connection with the aforementioned systems. The processes in FIG. 4-FIG. 5 can be implemented for example by systems 100, 200, or 300 illustrated in FIG. 1, FIG. 2, and FIG. 3 respectively.

FIG. 4 illustrates a flow diagram of an example, non-limiting embodiment of a method for configuring dependencies of top-level services and sub-services. At 400 (De-aggregate bundled services into top-level services and sub-services), the configuration process is initiated by de-aggregating bundles services into top-level services and sub-services. The bundled services can exist in a private cloud network or in a public cloud network, and can be accessed through a website, Internet, or other networks. The bundled services can also be all, or some portion, of the cloud services that a customer uses or subscribes to.

De-aggregating the bundled services can include receiving a list of sub-services used by the top-level services from a table that the vendor has provided, an audit by a third party, or by determining the sub-services that are called by the top-level services or are compatible with the top-level services.

At 410 (Map the top-level services and the sub-services to create a hierarchical dependency tree), when the bundled services are de-aggregated and information is extracted about the top-level services and the sub-services, the top-level services and the sub-services are mapped to create a hierarchical dependency tree. The hierarchical dependency tree may display not just the sub-services used by the top-level services, but also all the sub-services that are compatible with the top-level services as well.

At 420 (Configure dependencies of the top-level services and the sub-services and modify the hierarchical dependency tree based on a set of rules to consolidate the sub-services), the dependencies of top-level services and sub-services are configured and the hierarchy dependency tree is modified. The configuring of the dependencies can be based on a set of rules that are designed to consolidate the sub-services such that the top-level services use fewer sub-services. The set of rules can be defined to preferentially select specific sub-services.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5 illustrates a flow diagram of an example, non-limiting embodiment of a method for generating and modifying a hierarchical dependency tree of top-level services and sub-services. At 500 (Track usage of a top-level service and determine the sub-services used by the top-level service), usage of the top level services can be tracked, and based on the tracking, the sub-services used by the top-level service can be determined. The tracking can be accomplished by monitoring the service calls that the top-level services make that request a service from the sub-services.

At 510 (Receive a list of sub-services compatible with the top-level service), a list of sub-services compatible with the top-level service is received. The list of sub-services can be determined by analyzing the top-level service. Alternatively, the list of sub-services compatible with the top level can be compiled by a third party audit report, or can be received from the top-level service vendors, listing the sub-services that the top-level services are compatible with.

At 520 (Create a data store including information representative of the sub-services used and compatible with the top-level services), once the list of sub-services is received, a data store can be created that includes information representative of the sub-services used. The data store can also include information about other sub-services that are compatible with the top-level service. The data store can be stored in a data center or can be stored in the cloud.

At 530 (Generate a hierarchical dependency based on the data store), a hierarchical dependency tree can be generated based on the information in the data store. The hierarchical dependency tree represents relationships between the top-level services and the sub-services. The hierarchical dependency tree can be generated by analyzing the dependency and relationship information, and represents not just the sub-services that are used by the top-level services, but also represents the sub-services that are compatible with, or potentially could be used by the top-level services.

At 540 (Modify the hierarchical dependency tree based on a cost of the sub-service), once the hierarchical dependency tree is generated, the dependencies on the tree can be modified based on a cost of the sub-service. If a sub-service that is being used by the top-level service is more expensive than the cost of a sub-service that is compatible with the top-level service, the dependency can be modified so that the top-level service uses the lower cost sub-service. Information about the cost can be retrieved from a third party source, derived from the sub-service, or provided by a customer. The modification can be done directly, configuring the top-level service to switch to the lower cost sub-service, or can be accomplished by sending a request to the top-level service to change to the lower cost sub-service.

Alternatively, at 550 (Modify the hierarchical dependency tree in response to meeting a condition with respect to a volume of usage of the subservice), the hierarchical dependency tree can be modified in response to meeting or satisfying a condition with respect to a volume of usage of the sub-service. Since sub-services can offer discounts or bulk rates if a specified volume of usage is met, the hierarchical dependency tree can be modified to ensure that the volume of usage is met for at least one of the sub-services. If the top-level services are using a variety of sub-services for infrastructure support but a combination can be found where fewer sub-services are used with increased volume of usage per sub-service, the dependencies of the top-level services can be modified accordingly.

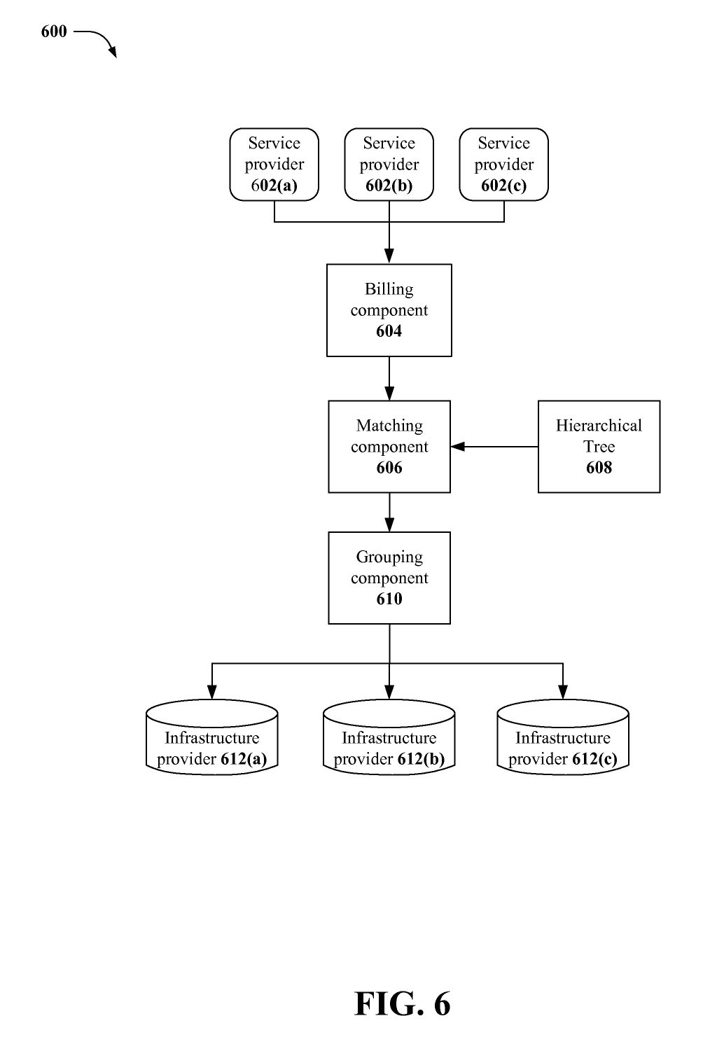

Turning now to FIG. 6, a block diagram illustrating an example, non-limiting embodiment of a billing system for sending infrastructure providers a consolidated transaction report is shown. As shown in FIG. 6, a system 600 is provided to take a number of itemized bills received from service providers, and break the itemized bills down, and send the infrastructure providers a report listing which services the infrastructure providers gave.

A billing component 604 can be configured to receive the itemized bills from service providers 602(a), 602(b) and 602(c). The itemized bills can be received digitally, or can be paper bills that are scanned by billing component 604 and turned into digital form. The itemized bills can include itemized costs for storage, storage transactions, compute time, data transfers, and so on. The items on the bills can be grouped functionally or chronologically. The items on the itemized bills can represent services provided by the service providers and the infrastructure providers.

A matching component 606 can be provided to match the items on the itemized bills to specific infrastructure providers. Matching component 606 can be configured to analyze the itemized bills from the service providers to determine which of the items on the itemized bills match with the infrastructure providers. Hierarchical tree 608 can contain information representing the relationships between the service providers and the infrastructure providers. Hierarchical tree 608 can also include information about the types of services rendered by the infrastructure providers that matching component 606 uses to match the items on the bills to the infrastructure providers.

In one embodiment, matching component 606 can analyze the itemized bill to determine that an item on a bill representing a particular operation was billed by the service provider. Matching component 606 can then determine from the hierarchical tree the infrastructure providers that are used by the service provider that supported the operation. Matching component 606 can then match that item representing the operation to the infrastructure provider.

Once the items are matched to particular infrastructure providers, a grouping component 610 can be configured to cluster all the matched items together by infrastructure provider, and grouping component 610 can create a transaction report for each infrastructure provider with all items matched to each respective infrastructure provider. The transaction reports can then be sent by grouping component 610 to infrastructure providers 612(a), 612(b), and 612(c).

The transaction reports can include information related to the volume of each service billed, and the cost of the services. The transaction reports can also list which service providers billed for each of the services provided to the customer. Transaction reports may also list specific times and dates, or transaction IDs, or other ways for the infrastructure providers to verify and account for the usage. The transaction reports enable the infrastructure providers to determine the total volume and cost of services that a customer ultimately uses from them, as well as the number of service providers that are intermediaries.

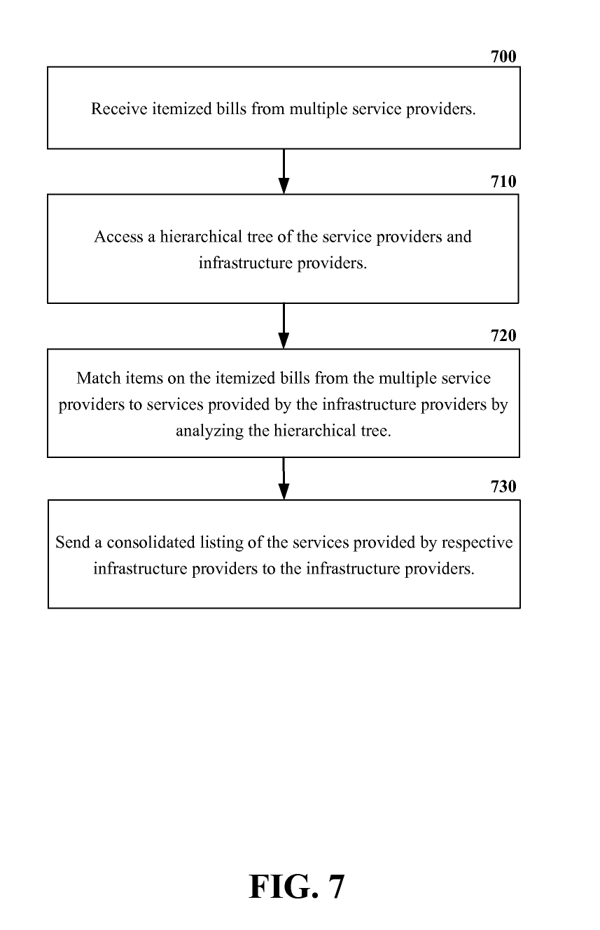

FIG. 7 illustrates a process in connection with the aforementioned system. The process in FIG. 7 can be implemented for example by system 600 illustrated in FIG. 6.

FIG. 7 illustrates a flow diagram of an example, non-limiting embodiment of a method for sending a consolidated listing of services to infrastructure providers. At 700 (Receive itemized bills from multiple service providers), a bill consolidation process is initiated by receiving itemized bills from multiple service providers. The itemized bills can be received digitally, or can be paper bills that are scanned, and subjected to an optical character recognition process to render the itemized bills electronically searchable. The itemized bills can include itemized costs for storage, storage transactions, compute time, and data transfers. The items on the bills can be grouped functionally or chronologically. The items on the itemized bills can represent services provided by the service providers and the infrastructure providers.

At 710 (Access a hierarchical tree of the service providers and infrastructure providers), a hierarchical tree of the service providers and the infrastructure providers can be accessed. The hierarchical tree can provide information about the relationships and dependencies between the service providers and the infrastructure providers. The hierarchical tree can also contain information about the infrastructure providers the service providers are using to provide services to the customer.

At 720 (Match items on the itemized bills from the multiple service providers to services provided by the infrastructure providers by analyzing the hierarchical tree), items on the itemized bills from the service providers can be matched to services provided by the infrastructure providers. The matching can be done by analyzing the itemized bills in conjunction with the hierarchical tree. The matching can determine the type of service or operation that each item on the itemized bills corresponds to, and then looking up the hierarchical tree and determining the infrastructure provider that could have provided each service. In this way, all the items on the itemized bill can be matched with specific infrastructure providers. The matching process may include the computation of rebates or incentive pricing that should be received by associating the infrastructure services across multiple service providers with the same final customer.

At 730 (Send a consolidated listing of the services provided by respective infrastructure providers to the infrastructure providers), a consolidated listing can be created that groups the items on the itemized bills by infrastructure provider. A transaction report for each infrastructure provider can be generated from the consolidated listing that lists all the items and services provided by the infrastructure provider. Transaction reports may also list specific times and dates, or transaction IDs, or other ways for the infrastructure providers to verify and account for the usage. Transaction reports for each infrastructure provider may then be sent to each of the respective infrastructure providers.

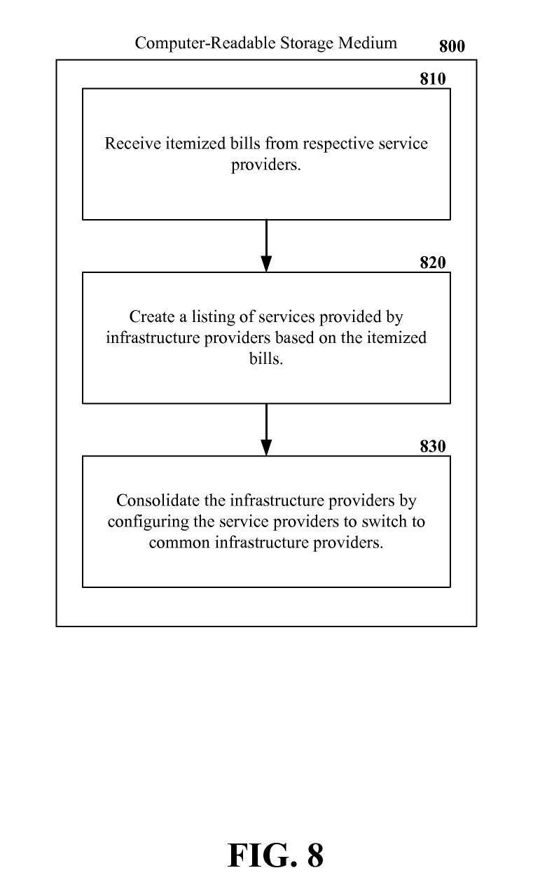

FIG. 8 illustrates a flow diagram of an example, non-limiting embodiment of a set of computer-readable instructions for consolidating infrastructure providers used by service providers. Computer-readable storage medium 800 can include computer executable instructions. At 810, the instructions can operate to receive itemized bills from respective service providers. The itemized bills from each service provider can list itemized costs for storage, storage transactions, compute times, and data transfers provided by infrastructure providers.

At 820, these instructions can operate to create a listing of services provided by the infrastructure providers based on the itemized bills. These instructions can also operate to create the listings that include price and volume of usage of the services provided by the infrastructure providers.

At 830, these instructions can operate to consolidate the infrastructure providers by including instructions to configure the service providers to switch to common infrastructure providers. The common infrastructure providers are infrastructure providers that are compatible with all the service providers. These instructions can include instructions for creating sets of infrastructure providers that are compatible with all of the service providers. Instructions can also be provided to determine a cost for each of the sets of infrastructure providers. The cost can be based on the price of a unit of volume of usage for each infrastructure provider and the total volume of usage for each of the infrastructure providers in the set.

Once the cost for each set of infrastructure providers is determined, these instructions can operate to select the set with the lowest cost. The instructions can operate to configure the service providers to switch to the lowest cost set of infrastructure providers, or can operate to send a request to the service provider to switch to the lowest cost set.

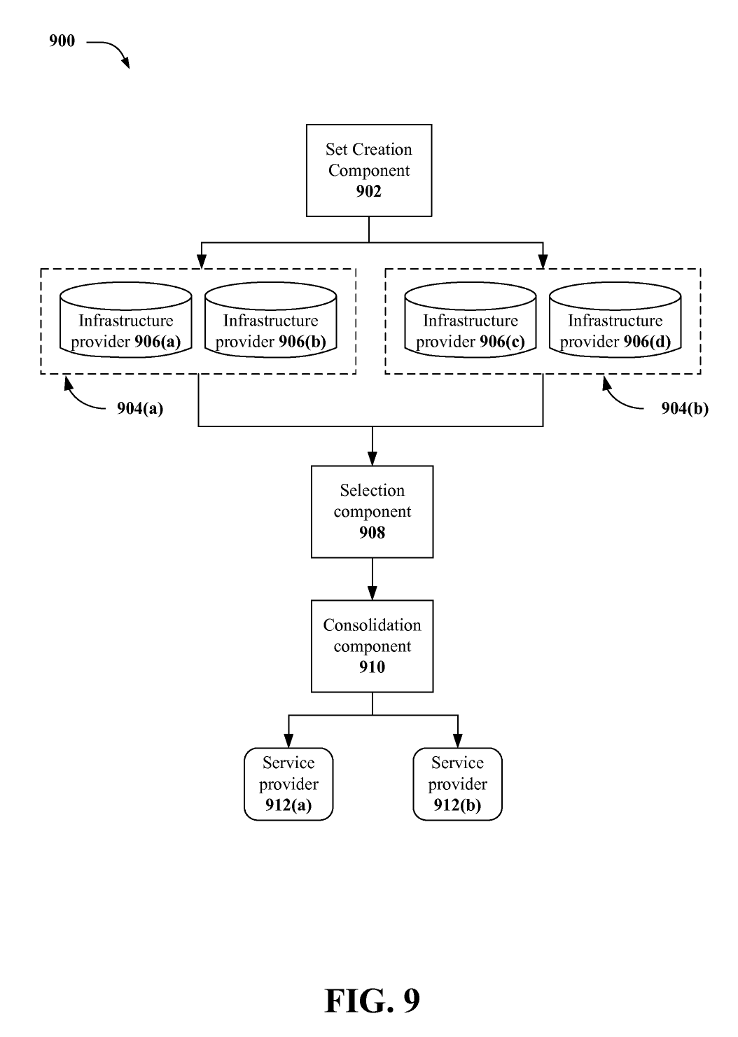

Turning now to FIG. 9, a block diagram illustrating an example, non-limiting embodiment of a system for selecting infrastructure providers is shown. As shown in FIG. 9, a set creation component 902 can create sets of infrastructure providers 904(a) and 904(b) that include infrastructure providers 906(a), 906(b), 906(c), and 906(d). A selection component 908 can analyze information relating to sets of infrastructure providers 904(a) and 904(b), and can select the set with the lowest cost or otherwise desirable metrics. A consolidation component 910 can send a request to the service providers 912(a) and 912(b) to switch to the set of infrastructure providers selected by selection component 908.

Set creation component 902 can be configured to create sets of infrastructure providers, wherein each of the sets of infrastructure providers 904(a) and 904(b) can be configured to provide all of the services used by service providers 912(a) and 912(b). Infrastructure providers 906(a), 906(b), 906(c), and 906(d) may not necessarily have to individually provide all the services used by the service providers, as long as the set of 906(a) and 906(b) the set of 906(c) and 906(d) can together provide all of the services. It is to be appreciated that while FIG. 9 shows sets 904(a) and 904(b) each having two infrastructure providers, any number and/or combination of infrastructure providers may constitute a set. Similarly, set creation component 902 can create any number of sets of infrastructure providers.

Selection component 908 can analyze the sets to determine the set of infrastructure providers that would provide the lowest cost. Selection component 908 can be configured to analyze information relating to a price per usage and a volume of usage of each of the infrastructure providers to determine the total cost of each set. Once the total cost of each set is determined, selection component 908 can be configured to select the set with lowest cost.

In an alternative embodiment, selection component 908 can consider potential bulk rates and discounts in selecting the set. Information about discount can be received directly from the infrastructure providers, or from other sources. Selection component 908 can then determine if usage of the infrastructure provider would enable the discount, and selection component 908 can then consider the discounted rate in determining the total cost of the set.

Consolidation component 910 can receive the selection from selection component 910, and consolidation component 910 can then be configured to send a request to service providers 912(a) and 912(b) to switch to using the set of infrastructure providers selected. In another embodiment, consolidation component 910 can be configured to directly modify the service providers to switch to the infrastructure providers selected by selection component 908.

### Example Computing Environment

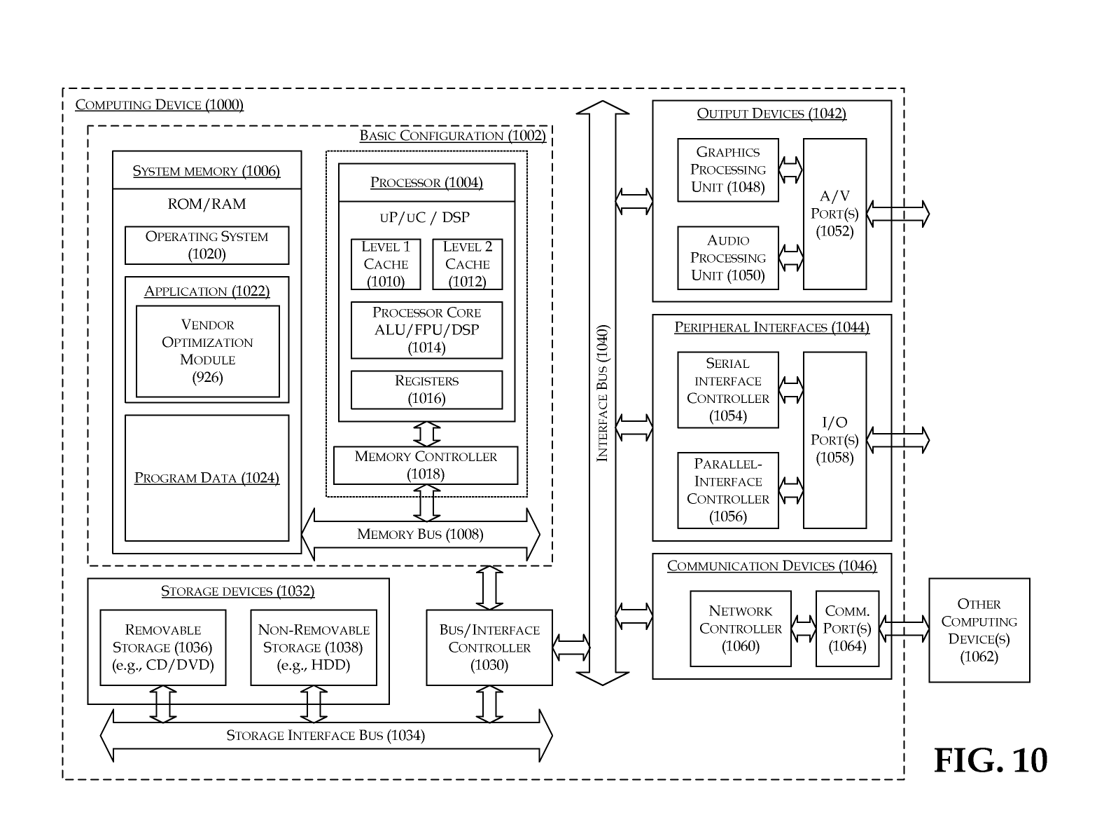

FIG. 10 is a block diagram illustrating an example computing device that is arranged for at least some of the embodiments of the subject disclosure. In a very basic configuration 1002, computing device 1000 typically includes one or more processors 1004 and a system memory 1006. A memory bus 1008 may be used for communicating between processor 1004 and system memory 1006.

Depending on the desired configuration, processor 1004 may be of any type including but not limited to a microprocessor (μP), a microcontroller (μE), a digital signal processor (DSP), or any combination thereof. Processor 1004 may include one more levels of caching, such as a level one cache 1010 and a level two cache 1012, a processor core 1014, and registers 1016. An example processor core 1014 may include an arithmetic logic unit (ALU), a floating point unit (FPU), a digital signal processing core (DSP Core), or any combination thereof. An example memory controller 1018 may also be used with processor 1004, or in some implementations memory controller 1018 may be an internal part of processor 1004.

Depending on the desired configuration, system memory 1006 may be of any type including but not limited to volatile memory (such as RAM), non-volatile memory (such as ROM, flash memory, etc.) or any combination thereof. System memory 1006 may include an operating system 1020, one or more applications 1022, and program data 1024. Application 1022 may include a vendor optimization module 1026 that is arranged to perform the functions as described herein. Program data 1024 may include vendor optimization process and resource information. In some embodiments, application 1022 may be arranged to operate with program data 1024 on operating system 1020.

Computing device 1000 may have additional features or functionality, and additional interfaces to facilitate communications between basic configuration 1002 and any required devices and interfaces. For example, a bus/interface controller 1030 may be used to facilitate communications between basic configuration 1002 and one or more data storage devices 1032 via a storage interface bus 1034. Data storage devices 1032 may be removable storage devices 1036, non-removable storage devices 1038, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1006, removable storage devices 1036 and non-removable storage devices 1038 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 1000. Any such computer storage media may be part of computing device 1000.

Computing device 1000 may also include an interface bus 1040 for facilitating communication from various interface devices (e.g., output devices 1042, peripheral interfaces 1044, and communication devices 1046) to basic configuration 1002 via bus/interface controller 1030. Example output devices 1042 include a graphics processing unit 1048 and an audio processing unit 1050, which may be configured to communicate to various external devices such as a display or speakers via one or more A/V ports 1052. Example peripheral interfaces 1044 include a serial interface controller 1054 or a parallel interface controller 1056, which may be configured to communicate with external devices such as input devices (e.g., keyboard, mouse, pen, voice input device, touch input device, etc.) or other peripheral devices (e.g., printer, scanner, etc.) via one or more I/O ports 1058. An example communication device 1046 includes a network controller 1060, which may be arranged to facilitate communications with one or more other computing devices 1062 over a network communication link via one or more communication ports 1064.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1000 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 may also be implemented as a personal computer including both laptop computer and non-laptop computer configurations.

### Example Networking Environment

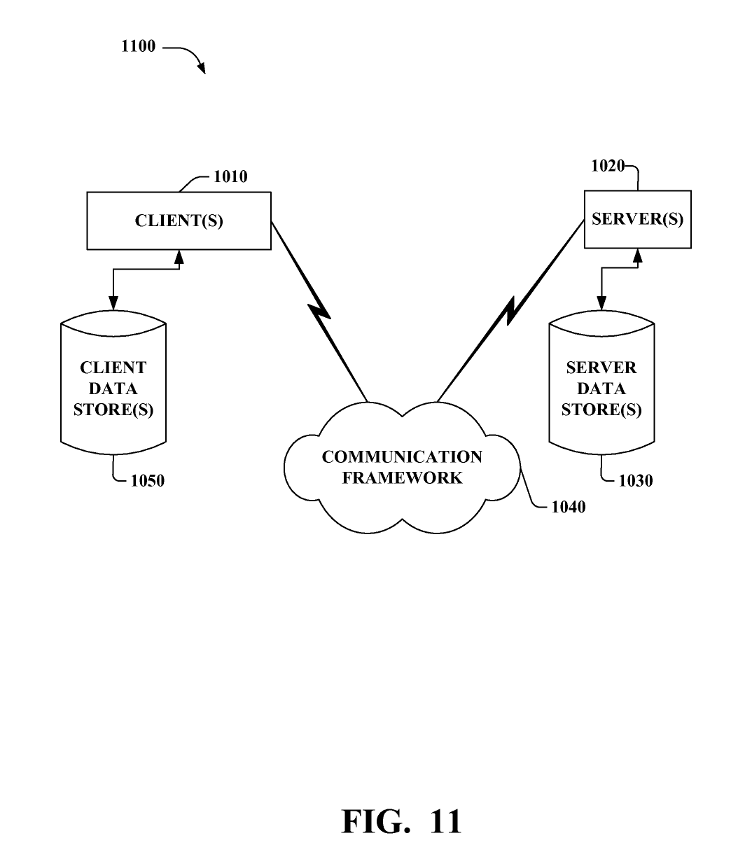

Turning now to FIG. 11 a block diagram illustrating an example networking environment that can be employed in accordance with the claimed subject matter is shown. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

The subject disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The subject disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the subject disclosure have been described herein for purposes of illustration, and that various modifications may be made without departing from the scope and spirit of the subject disclosure. Accordingly, the various embodiments disclosed herein are not intended to be limiting, with the true scope and spirit being indicated by the following claims.

What is claimed is:

1. A method, comprising:
receiving itemized bills from a plurality of service providers;
accessing a hierarchical tree of the service providers and infrastructure providers;
matching items on the itemized bills from the plurality of service providers to services provided by the infrastructure providers including analyzing the hierarchical tree; and
sending a consolidated listing of the services provided by respective infrastructure providers to the infrastructure providers.

2. The method of claim 1, wherein the matching the items further comprises determining that the plurality of service providers used the infrastructure providers.

3. The method of claim 1, wherein the sending the consolidated listing of the services comprises sending a price and a usage of respective services provided by the infrastructure providers as billed by the plurality of service providers.

4. A computer readable storage medium having computer executable instructions that, in response to execution, cause a computing system to perform operations, comprising:
receiving itemized bills from respective service providers;
creating a listing of services provided by infrastructure providers based on the itemized bills, wherein the listing of services comprises a price and a usage of the services; and
consolidating the infrastructure providers by configuring the service providers to switch to common infrastructure providers.

5. The computer readable storage medium of claim 4, wherein the receiving the itemized bills further comprises receiving itemized costs for storage, a storage transaction, a compute time, and a data transfer for respective infrastructure providers of the infrastructure providers used by the plurality of service providers.

6. The computer readable storage medium of claim 4, wherein the consolidating the infrastructure providers further comprises:
creating sets of the infrastructure providers;
determining a cost for the sets of the infrastructure providers; and
selecting a set of infrastructure providers from the sets with a lowest cost.

7. The computer readable storage medium of claim 6, wherein the creating the sets further comprises ensuring that the set of infrastructure providers links to the service providers on a hierarchical tree of the service providers and the infrastructure providers.

8. A system, comprising:
a billing component configured to receive itemized bills from service providers;
a matching component configured to analyze the itemized bills and a hierarchical tree of the service providers and infrastructure providers, and match items from the itemized bills to the infrastructure providers; and
a grouping component configured to cluster the items matched to the infrastructure providers and send the infrastructure providers a grouped transaction report.

9. The system of claim 8, wherein the hierarchical tree of the service providers and the infrastructure providers represents dependencies between the infrastructure providers and the service providers.

10. The system of claim 8, wherein the itemized bills comprise information related to services provided by the service providers and the infrastructure providers that provided the services.

11. The system of claim 8, wherein the grouped transaction report comprises information about a price and a usage of each of the services provided by each of the infrastructure providers as billed by the service providers.

12. A system, comprising:
means for matching items on itemized bills from a plurality of service providers to services provided by a plurality of infrastructure providers;
means for consolidating the items from the itemized bills into groups based on the services provided by the plurality of infrastructure providers; and
means for sending a consolidated list of the services provided by an infrastructure provider to the plurality of infrastructure providers.

13. The system of claim 12, wherein the means for matching comprises means for determining that the plurality of service providers used the services provided by the plurality of infrastructure providers.
